(19) United States
(12) Patent Application Publication
(10) Pub. No.: US 2025/0230090 A1
(43) Pub. Date: Jul. 17, 2025

(54) LAMINATED GLASS AND VEHICLE

(71) Applicant: FUYAO GLASS INDUSTRY GROUP CO., LTD., Fuqing City (CN)

(72) Inventors: Jun LIN, Fuqing City Fuzhou (CN); Zhe WANG, Fuqing City Fuzhou (CN); Li WANG, Fuqing City Fuzhou (CN)

(73) Assignee: FUYAO GLASS INDUSTRY GROUP CO., LTD., Fuqing City (CN)

(21) Appl. No.: 19/097,404

(22) Filed: Apr. 1, 2025

Related U.S. Application Data
(63) Continuation of application No. PCT/CN2023/124644, filed on Oct. 16, 2023.

(30) Foreign Application Priority Data
Oct. 17, 2022 (CN) 202211265283.3

(51) Int. Cl. C03C 3/097; B32B 17/10

(52) U.S. Cl. CPC C03C 3/097; B32B 17/10036; B32B 17/10119; B32B 17/10761; B32B 2250/03; B32B 2307/7376

(57) ABSTRACT

Laminated glass is provided. The laminated glass includes outer glass, an intermediate layer, and inner glass. The intermediate layer is located between the outer glass and the inner glass. A composition of the outer glass and a composition of the inner glass both include total iron expressed as Fe₂O₃. A mass percentage content of the total iron in the outer glass is Wₒᵤₜₑᵣ based on a mass of the outer glass, a mass percentage content of the total iron in the inner glass is Wᵢₙₙₑᵣbased on a mass of the inner glass, and Wₒᵤₜₑᵣ and Wᵢₙₙₑᵣ satisfy: 10%>Wₒᵤₜₑᵣ*Tₒᵤₜₑᵣ+Wᵢₙₙₑᵣ*Tᵢₙₙₑᵣ>4%. Tₒᵤₜₑᵣ is a thickness of the outer glass in a unit of mm, and Tᵢₙₙₑᵣ is a thickness of the inner glass in a unit of mm.

### CROSS-REFERENCE TO RELATED APPLICATION(S)

The application is a continuation of International Application No. PCT/CN2023/124644, filed Oct. 16, 2023, which claims priority to Chinese Patent Application No. 202211265283.3, filed Oct. 17, 2022, the entire disclosure of which are hereby incorporated by reference.

### TECHNICAL FIELD

This disclosure relates to the field of glass technology, and in particular, to laminated glass and a vehicle.

### BACKGROUND

According to regulations, in an existing vehicle, a front windshield and front-door glass have a visible region requiring a high visible light transmittance, but glass mounted at a rear door, a sunroof, a rear window, and the like is often required to have a high heat insulation performance, for which glass with a high visible light transmittance cannot satisfy the requirement for heat insulation.

### SUMMARY

In a first aspect, laminated glass is provided in the present disclosure. The laminated glass includes outer glass, an intermediate layer, and inner glass. The intermediate layer is located between the outer glass and the inner glass. A composition of the outer glass and a composition of the inner glass both include total iron expressed as Fe₂O₃. A mass percentage content of the total iron in the outer glass is Wₒᵤₜₑᵣ based on a mass of the outer glass, a mass percentage content of the total iron in the inner glass is Wᵢₙₙₑᵣ based on a mass of the inner glass, and Wₒᵤₜₑᵣ and Wᵢₙₙₑᵣ satisfy: 10%≥Wₒᵤₜₑᵣ*Tₒᵤₜₑᵣ+Wᵢₙₙₑᵣ*Tᵢₙₙₑᵣ≥4%. Tₒᵤₜₑᵣ is a thickness of the outer glass in a unit of mm, and Tᵢₙₙₑᵣ is a thickness of the inner glass in a unit of mm.

In a second aspect, a vehicle is further provided in the present disclosure. The vehicle includes a vehicle body and laminated glass. The laminated glass includes outer glass, an intermediate layer, and inner glass. The intermediate layer is located between the outer glass and the inner glass. A composition of the outer glass and a composition of the inner glass both include total iron expressed as Fe₂O₃. A mass percentage content of the total iron in the outer glass is Wₒᵤₜₑᵣ based on a mass of the outer glass, a mass percentage content of the total iron in the inner glass is Wᵢₙₙₑᵣ based on a mass of the inner glass, and Wₒᵤₜₑᵣ and Wᵢₙₙₑᵣ satisfy: 10%≥Wₒᵤₜₑᵣ*Tₒᵤₜₑᵣ+Wᵢₙₙₑᵣ*Tᵢₙₙₑᵣ≥4%. Tₒᵤₜₑᵣ is a thickness of the outer glass in a unit of mm, and Tᵢₙₙₑᵣ is a thickness of the inner glass in a unit of mm. The laminated glass is mounted at the vehicle body.

### BRIEF DESCRIPTION OF THE DRAWINGS

To describe technical solutions in embodiments of the present disclosure or in the related art more clearly, the following will briefly introduce the accompanying drawings required for describing the embodiments or the related art. Apparently, the accompanying drawings in the following description illustrate merely some embodiments of the present disclosure, and those of ordinary skill in the art may obtain other accompanying drawings from these accompanying drawings without creative effort.

FIG. 1 is a schematic structural view of a vehicle provided in the present disclosure.

FIG. 2 is a schematic cross-sectional structural view of laminated glass in the vehicle illustrated in FIG. 1.

Reference signs in the accompanying drawings are described as follows: 1000—vehicle; 100—laminated glass; 200—vehicle body; 10—outer glass; 20—inner glass; 30—intermediate layer.

### DETAILED DESCRIPTION

The following will describe technical solutions in embodiments of the present disclosure clearly and completely with reference to the accompanying drawings in embodiments of the present disclosure. Apparently, embodiments described herein are merely some embodiments, rather than all embodiments, of the present disclosure. Based on the embodiments of the present disclosure, all other embodiments obtained by those of ordinary skill in the art without creative effort shall fall within the protection scope of the present disclosure.

An objective of the present disclosure is to provide laminated glass and a vehicle. The laminated glass has a low visible light transmittance (TL) and total solar energy transmittance (TTS), and has a high heat insulation performance, which can be used as a component that has a high requirement for heat insulation performance, such as rear-door glass, sunroof glass, or rear window glass.

Laminated glass is provided in the present disclosure. The laminated glass includes outer glass, an intermediate layer, and inner glass. The intermediate layer is located between the outer glass and the inner glass. A composition of the outer glass and a composition of the inner glass both include total iron expressed as Fe₂O₃. A mass percentage content of the total iron in the outer glass is Wₒᵤₜₑᵣ based on a mass of the outer glass, a mass percentage content of the total iron in the inner glass is Wᵢₙₙₑᵣ based on a mass of the inner glass, and Wₒᵤₜₑᵣ and Wᵢₙₙₑᵣ satisfy: 10%≥Wₒᵤₜₑᵣ*Tₒᵤₜₑᵣ+Wᵢₙₙₑᵣ*Tᵢₙₙₑᵣ≥4%. Tₒᵤₜₑᵣ is a thickness of the outer glass in a unit of mm, and Tᵢₙₙₑᵣ is a thickness of the inner glass in a unit of mm.

Wₒᵤₜₑᵣ ranges from 1 wt % to 1.9 wt %, and Wᵢₙₙₑᵣ ranges from 0.08 wt % to 1.9 wt %.

Tₒᵤₜₑᵣ ranges from 1.6 mm to 5.0 mm, and Tᵢₙₙₑᵣ ranges from 0.1 mm to 1.2 mm.

The laminated glass has a total solar energy transmittance less than or equal to 45%.

The laminated glass has a visible light transmittance less than or equal to 25%.

In the outer glass, a ratio of a content of ferrous iron to a content of ferric iron ranges from 0.25 to 0.67. In the inner glass, a ratio of a content of ferrous iron to a content of ferric iron ranges from 0.25 to 0.67.

The composition of the outer glass further includes total cobalt expressed as Co₂O₃. A mass percentage content of the total cobalt in the outer glass is W_{Co} based on the mass of the outer glass, and W_{Co} ranges from 0.01 wt % to 0.04 wt %.

Wₒᵤₜₑᵣ: W_{Co}=55-75.

Based on the mass of the outer glass, the composition of the outer glass includes SiO₂ of 65 wt %-75 wt %, Na₂O of 10 wt %-20 wt %, CaO of 5 wt %-15 wt %, MgO of 0 wt %-5 wt %, K₂O of 0 wt %-3 wt %, Al₂O₃ of 0 wt %-5 wt %, Fe₂O₃ of 1 wt %-1.9 wt %, Co₂O₃ of 0.01 wt %-0.1 wt %, Cr₂O₃ of 0 wt %-0.1 wt %, CeO₂ of 0 wt %-0.1 wt %, MnO of 0 wt %-0.01 wt %, NiO of 0 wt %-0.01 wt %, ZrO₂ of 0 wt %-1 wt %, B₂O₃ of 0 wt %-1 wt %, and P₂O₅ of 0 wt %-1 wt %.

Based on the mass of the inner glass, the composition of the inner glass includes SiO₂ of 55 wt %-65 wt %, Al₂O₃ of 0 wt %-22 wt %, Na₂O of 8 wt %-18 wt %, Li₂O of 0 wt %-5 wt %, CaO of 0 wt %-2 wt %, MgO of 0 wt %-5 wt %, K₂O of 0 wt %-10 wt %, Fe₂O₃ of 0.08 wt %-1.9 wt %, ZrO₂ of 0 wt %-2 wt %, B₂O₃ of 0 wt %-5 wt %, and P₂O₅ of 0 wt %-1 wt %.

The composition of the inner glass includes alkaline-earth metal oxide, and a total content of the alkaline-earth metal oxide is less than 5 wt % based on the mass of the inner glass.

A transmitted color of the outer glass has a value of L ranging from 29 to 56, a value of a ranging from −5 to −2, and a value of b ranging from 2 to 4 in a color space Lab.

A transmitted color of the inner glass has a value of L ranging from 40 to 92, a value of a ranging from −4 to 1, and a value of b ranging from 0 to 2 in a color space Lab.

A vehicle is further provided in the present disclosure. The vehicle includes a vehicle body and the laminated glass described above. The laminated glass is mounted at the vehicle body.

For the laminated glass provided in the present disclosure, the content Wₒᵤₜₑᵣ of the total iron in the outer glass and the content Wᵢₙₙₑᵣ of the total iron in the inner glass are controlled to satisfy: 10%≥Wₒᵤₜₑᵣ*Tₒᵤₜₑᵣ+Wᵢₙₙₑᵣ*Tᵢₙₙₑᵣ≥4%, and thus the formed laminated glass can have a low visible TL and TTS. As such, the laminated glass has a good heat insulation performance, which can be used as a component that has a high requirement for heat insulation performance, such as rear-door glass, sunroof glass, or rear window glass. In addition, Fe₂O₃ is added to both the outer glass and the inner glass in the laminated glass, thereby avoiding the problems of excessive cost and high production energy consumption due to the use of clear glass.

Laminated glass 100 provided in embodiments of the present disclosure may be applied to the field of vehicles, so as to serve a function of protection. It may be understood that, according to requirements, the laminated glass 100 may also be applied by those skilled in the art to other fields such as the architectural field. In the following embodiments of the present disclosure, for example, the laminated glass 100 is merely applied to a vehicle.

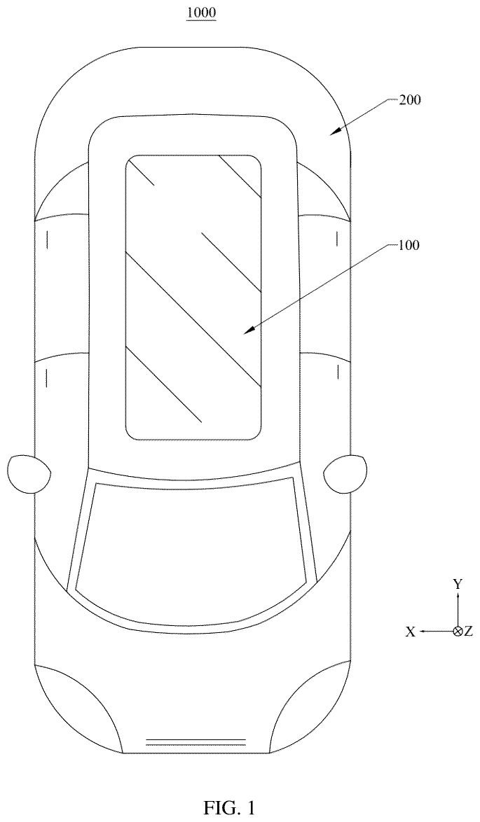

Reference is made to FIG. 1, where FIG. 1 is a schematic structural view of a vehicle 1000 provided in the present disclosure.

For ease of illustration, a width direction of the vehicle 1000 illustrated in FIG. 1 is defined as an X-axis direction, a length direction of the vehicle 1000 is defined as a Y-axis direction, and a height direction of the vehicle 1000 is defined as a Z-axis direction.

The vehicle 1000 includes laminated glass 100 and a vehicle body 200. The laminated glass 100 is mounted at the vehicle body 200. The laminated glass 100 can be used as rear-door glass, sunroof glass, rear window glass, or the like. In FIG. 1, for example, the laminated glass 100 is merely the sunroof glass.

The laminated glass 100 is configured to allow light outside the vehicle 1000 to enter the interior of the vehicle 1000, and the laminated glass 100 has a good heat insulation effect, which can improve the riding experience in the vehicle 1000. A positive direction of Z-axis is a direction from the exterior of the vehicle 1000 toward the interior of the vehicle 1000.

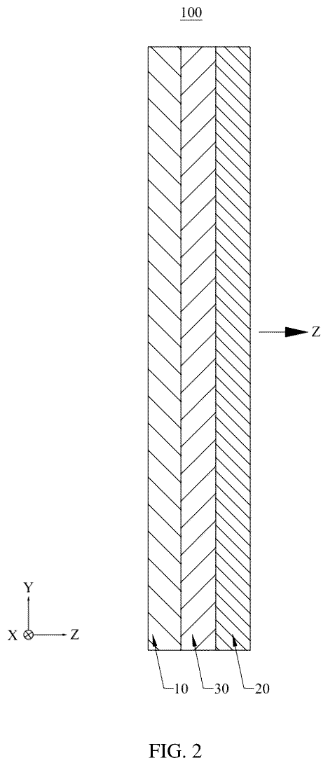

Reference is made to FIG. 2, where FIG. 2 is a schematic cross-sectional structural view of laminated glass 100 in the vehicle 1000 illustrated in FIG. 1.

In the positive direction of Z-axis, the laminated glass 100 sequentially includes outer glass 10, an intermediate layer 30, and inner glass 20. The intermediate layer 30 is located between the outer glass 10 and the inner glass 20. After the laminated glass 100 is mounted on the vehicle, the outer glass 10 faces the exterior of the vehicle 1000, and the inner glass 20 faces the interior of the vehicle 1000.

Specifically, a system of the outer glass 10 may be soda-lime silicate glass. Exemplarily, based on a mass of the outer glass 10, a composition of the outer glass 10 provided in this embodiment includes SiO₂ of 65 wt %-75 wt %, Na₂O of 10 wt %-20 wt %, CaO of 5 wt %-15 wt %, MgO of 0 wt %-5 wt %, K₂O of 0 wt %-3 wt %, Al₂O₃ of 0 wt %-5 wt %, Fe₂O₃ of 1 wt %-1.9 wt %, CO₂O₃ of 0.01 wt %-0.1 wt %, Cr₂O₃ of 0 wt %-0.1 wt %, CeO₂ of 0 wt %-0.1 wt %, MnO of 0 wt %-0.01 wt %, NiO of 0 wt %-0.01 wt %, ZrO₂ of 0 wt %-1 wt %, B₂O₃ of 0 wt %-1 wt %, and P₂O₅ of 0 wt %-1 wt %.

By using mineral raw materials of the same grade, a raw sheet of the outer glass 10 is produced according to the above composition range of the outer glass 10, and then the raw sheet is sequentially subjected to cutting-edging-physical thermal strengthening, so as to obtain to-be-used outer glass 10. The physical thermal strengthening refers to heating the outer glass 10 to a certain temperature between an upper annealing temperature and a softening temperature of the outer glass 10, and then rapidly cooling a surface of the outer glass 10 to below an annealing temperature by using ambient-temperature compressed air. During this process, a surface layer of the outer glass 10 is rapidly cooled and quickly solidified, and due to the continuous cooling of a core layer of the outer glass 10, the surface layer undergoes a shrinkage stress (usually between 90 megapascals (MPa) and 150 MPa) and generates a surface compressive stress, and the corresponding core layer generates a central tensile stress, so that the outer glass 10 is physically thermally strengthened, and thus the strength of the outer glass 10 can be improved. In some embodiments, the physically thermally strengthened outer glass 10 has a surface stress ranging from 30 MPa to 150 MPa. It may be understood that, since chemical tempering is not needed for the outer glass 10 (reference can be made to a chemical tempering process of the inner glass 20 below), and there is no need for ion exchange, Li₂O does not need to be added to the outer glass 10.

During production of glass, in a melting furnace, a reducing atmosphere contributes to the generation of ferrous iron, and an oxidizing atmosphere contributes to the generation of ferric iron. In addition, since different tail gases may be generated from the combustion of fuel, and the tail gases of different compositions may have different redox abilities, in order to guarantee a color tone of the glass, a high-temperature atmosphere in the furnace needs to be controlled, which is represented by a redox coefficient. This coefficient is generally controlled within a range of 0.2 to 0.4, and the redox coefficient is a coefficient related to various aspects such as reducers, oxidizers, and combustion characteristics. In embodiments of the present disclosure, in the outer glass 10, a ratio of a content of ferrous iron to a content of ferric iron ranges from 0.25 to 0.67. Since iron may exhibit different colors in different valence states, ferrous iron makes the glass colored light blue and has a strong coloring ability, and ferric iron makes the glass colored yellow and has a weak coloring ability, an expected grey black color can only be obtained by controlling the ratio of the content of the ferrous iron to the content of the ferric iron in the outer glass 10 to satisfy the range of 0.25 to 0.67 and mixing with a certain proportion of cobalt for coloring. In some embodiments, a transmitted color of the outer glass 10 has a value of L ranging from 29 to 56, a value of a ranging from −5 to −2, and a value of b ranging from 2 to 4 in a color space Lab. According to a testing system of the CIE1976LAB color space, the values of the transmitted color of the outer glass 10 in the color space Lab are measured based on parameters of illuminant D65 and 10-degree observer, where L represents a lightness value, a represents a red-green chromaticity value, and b represents a yellow-blue chromaticity value.

The composition of the outer glass 10 includes total iron expressed as Fe₂O₃, and a mass percentage content of the total iron in the outer glass 10 is Wₒᵤₜₑᵣ based on the mass of the outer glass 10. Exemplarily, Wₒᵤₜₑᵣ ranges from 1 wt % to 1.9 wt %. The composition of the outer glass 10 includes total cobalt expressed as Co₂O₃. Exemplarily, based on the mass of the outer glass 10, a mass percentage content W_{Co} of the total cobalt ranges from 0.01 wt % to 0.04 wt %. Both Fe₂O₃ and CO₂O₃ are added to the outer glass 10, so as to control a color of the outer glass 10. In some specific embodiments, by controlling Wₒᵤₜₑᵣ:W_{Co}=55-75, the outer glass 10 can be colored grey black with a relatively low light transmittance. When the ratio of Wₒᵤₜₑᵣ to W_{Co} is out of the range of 55 to 75, for one thing, the color of the outer glass 10 may not conform to expectations, for example, excessive total cobalt may make the outer glass 10 appear dark blue, and excessive total iron may make the outer glass 10 appear blue-green or brown. For another, if a ratio of Fe₂O₃ and CO₂O₃ is inappropriate, the heat absorption performance of glass melts may change during production of the outer glass 10, so that the heat exchange disorder in the furnace may occur, the fining, homogenizing, and tin-bath thinness-drawing of the glass melts all cannot be successfully completed, and thus the quality of the raw sheet of the outer glass 10 is affected. In addition, a refractive index and a coefficient of thermal expansion of the outer glass 10 may be adjusted by adding P₂O₅ and B₂O₃ to the composition of the outer glass 10.

Specifically, a system of the inner glass 20 may be soda-lime silicate glass or aluminosilicate glass. The inner glass 20 needs to be chemically strengthened to have a sufficient strength, and is preferably the aluminosilicate glass. Exemplarily, based on a mass of the inner glass 20, a composition of the inner glass 20 provided in this embodiment includes SiO₂ of 55 wt %-65 wt %, Al₂O₃ of 0 wt %-22 wt %, Na₂O of 8 wt %-18 wt %, Li₂O of 0 wt %-5 wt %, CaO of 0 wt %-2 wt %, MgO of 0 wt %-5 wt %, K₂O of 0 wt %-10 wt %, Fe₂O₃ of 0.08 wt %-1.9 wt %, ZrO₂ of 0 wt %-2 wt %, B₂O₃ of 0 wt %-5 wt %, and P₂0₅ of 0 wt %-1 wt %.

By using mineral raw materials of the same grade, a raw sheet of the inner glass 20 is produced according to the above composition range of the inner glass 20, and then the raw sheet is sequentially subjected to cutting-edging-thermally bending-chemical tempering, so as to obtain to-be-used inner glass 20. A temperature for the chemical tempering ranges from 380° C. to 460° C., and a time for the chemical tempering is between 30 min and 16 h. For the soda-lime silicate glass, preferably, the temperature for the chemical tempering is 420° C., and the time for the chemical tempering ranges from 8 h to 16 h. For the aluminosilicate glass, preferably, the temperature for the chemical tempering is 430° C., and the time for the chemical tempering ranges from 0.5 h to 4 h. In other embodiments of the present disclosure, the inner glass 20 having a thickness within 1.4 mm may also be subjected to cold bending, so as to obtain a required curved surface. The chemical tempering refers to preheating the inner glass 20 to a temperature approximate to the chemical tempering temperature, then putting the inner glass 20 into molten potassium nitrate preset with the tempering temperature, and performing ion exchange for a period of time. An exchange of small-radius Na⁺ in the glass for large-radius K⁺ in a salt bath forms the squeezing effect, and a micron-sized stress layer depth and a compressive stress of several hundred MPa are generated on a surface of the inner glass 20, so that the inner glass 20 is chemically tempered, and thus the strength of the inner glass 20 can be improved. In some embodiments, the chemically tempered inner glass 20 has a surface stress ranging from 300 MPa to 1000 MPa.

The composition of the inner glass 20 includes total iron expressed as Fe₂O₃. A mass percentage content of the total iron in the inner glass 20 is Wᵢₙₙₑᵣ based on the mass of the inner glass 20. Exemplarily, Wᵢₙₙₑᵣ ranges from 0.08 wt % to 1.9 wt %. Similar to the production of the outer glass 10, under the influence of tail gases generated from the fuel, ferrous iron and ferric iron may be formed after the production of the inner glass 20. In the inner glass 20, a ratio of a content of ferrous iron to a content of ferric iron ranges from 0.25 to 0.67, so as to adjust a color of the inner glass 20. In some embodiments, a transmitted color of the inner glass 20 has a value of L ranging from 40 to 92, a value of a ranging from −4 to 1, and a value of b ranging from 0 to 2 in a color space Lab. A range of the transmitted color of the inner glass 20 in the color space Lab is obtained in the same method for measuring the values of the transmitted color of the outer glass 10 in the color space Lab, and for details, reference can be made to the above content for measuring the values of the transmitted color of the outer glass 10 in the color space Lab. In addition, based on the mass of the inner glass 20, in the composition of the inner glass 20, in addition to Fe₂O₃, a content of a colorant for coloring the inner glass 20 is controlled below 0.1 wt % to reduce the content of the colorant, so that the problems that, due to the excessive colorant content, the glass melts at the bottom of the melting furnace are melted difficultly and the raw sheet of the inner glass 20 cannot be produced, may not occur.

In some embodiments, a total content of alkaline-earth metal oxide in the inner glass 20 is less than 5 wt % based on the mass of the inner glass 20. Exemplarily, the alkaline-earth metal oxide includes CaO, MgO, and the like. In terms of controlling a range of the total content of the alkaline-earth metal oxide, for one thing, the alkaline-earth metal oxide is involved as a network intermediate in the structure of the inner glass 20, which may block an ion exchange channel during the chemical tempering of the inner glass 20, thereby reducing the exchange efficiency of K⁺ in the salt bath used for the chemical tempering and Na⁺ in the inner glass 20. For another, the alkaline-earth metal oxide, especially CaO, has a significant influence on the service life of the salt bath, and even if a small amount of the alkaline-earth metal oxide enters the potassium nitrate salt bath during the ion exchange, the salt bath will fail and the stress and stress layer depth for chemical tempering will be reduced. Therefore, by controlling the total content of the alkaline-earth metal oxide in the inner glass 20 at a relatively low content, the efficiency of chemical tempering can be improved, and the service life of the salt bath can be extended. In addition, when the total content of the alkaline-earth metal oxide is less than 5 wt %, percentage quotas of a difference between the total content of the alkaline-earth metal oxide and 5 wt % can be given to aluminium oxide or sodium oxide, thereby reducing the production cost of the inner glass 20.

By adding Li₂O to the inner glass 20, the melting temperature of the glass melts can be significantly reduced, and the efficiency of ion exchange can be improved. Adding only a small amount of Li₂O can improve the overall performance of the inner glass. Li₂O, B₂O₃, and P₂O₅ added to the composition of the inner glass 20 can be used to adjust a refractive index and a coefficient of thermal expansion of the inner glass 20, and can also reduce the melting temperature of the glass melts, thereby reducing energy consumption, and improving the efficiency of ion exchange during the chemical tempering of the inner glass 20.

Specifically, the intermediate layer 30 is a polymer layer for bonding the outer glass 10 and the inner glass 20. Exemplarily, the intermediate layer 30 is polyvinyl butyral resin (PVB).

The laminated glass 100 is prepared as follows. A PVB layer is used as the intermediate layer 30 and is placed between the to-be-used outer glass 10 obtained after the physical thermal strengthening and the to-be-used inner glass 20 obtained after the chemical tempering, and the outer glass 10, the intermediate layer 30, and the inner glass 20 are laminated together to obtain the laminated glass 100. In the prepared laminated glass 100, an area of the inner glass 20 is less than an area of the outer glass 10. A thickness of the outer glass 10 is Tₒᵤₜₑᵣ in a unit of mm (millimeter). Exemplarily, Tₒᵤₜₑᵣ ranges from 1.6 mm to 5.0 mm. A thickness of the inner glass 20 is Tᵢₙₙₑᵣ in a unit of mm (millimeter). The thickness Tᵢₙₙₑᵣ of the inner glass 20 is less than the thickness Tₒᵤₜₑᵣ of the outer glass 10, and exemplarily, Tᵢₙₙₑᵣ ranges from 0.1 mm to 1.2 mm. Exemplarily, a thickness of the intermediate layer 30 is 0.76 mm.

In existing asymmetric laminated glass, the outer glass and the inner glass have greatly different colors and thicknesses, and are often produced in different float-melting furnaces. For example, the outer glass with a relatively large thickness often uses a melting furnace with a high tonnage, a high melting volume, and a low melting temperature, and the inner glass with a relatively small thickness often uses a melting furnace with a low tonnage, a low melting volume, and a high melting temperature, which significantly increases the energy consumption cost for producing a raw sheet of glass and the transportation cost of the raw sheet. In the laminated glass 100 of embodiments of the present disclosure, when the content Wₒᵤₜₑᵣ of the total iron in the outer glass 10 is close to the content Wᵢₙₙₑᵣ of the total iron in the inner glass 20, the outer glass 10 and the inner glass 20 can be separately produced in the same furnace, thereby reducing the production cost. When the content Wₒᵤₜₑᵣ of the total iron in the outer glass 10 is equal to the content Wᵢₙₙₑᵣ of the total iron in the inner glass 20, the outer glass 10 can be produced in one furnace and one of two tin-bath-annealing lines, and at the same time the inner glass 20 with a different thickness from the outer glass 10 can be produced in the one furnace and the other one of the two tin-bath-annealing lines, so that the laminated glass 100 with an asymmetric structure is formed, and thus the production cost is reduced. In embodiments of the present disclosure, by setting Wₒᵤₜₑᵣ to be close to or equal to Wᵢₙₙₑᵣ, two production methods for producing the outer glass 10 and the inner glass 20 both can greatly reduce the production cost, so that the raw material cost of the asymmetric laminated glass 100 is close to the cost of laminated glass with a conventional symmetric structure.

In addition, the refractive index of the outer glass 10 may be adjusted by adding P₂O₅ and B₂O₃ to the composition of the outer glass 10, and the refractive index of the inner glass 20 may be adjusted by adding Li₂O, B₂O₃, and P₂O₅ to the composition of the inner glass 20, so that the refraction of light by the outer glass 10 and the inner glass 20 tends to be consistent. As such, the effect of observing an object through the laminated glass 100 is closer to the effect of a single sheet of glass, thereby reducing the observation position deviation and dispersion effect, and improving the appearance.

Furthermore, the outer glass 10 and the inner glass 20 are adjusted to satisfy: 10%≥Wₒᵤₜₑᵣ*Tₒᵤₜₑᵣ+Wᵢₙₙₑᵣ*Tᵢₙₙₑᵣ≥4%, and thus the laminated glass 100 can have a low visible light transmittance (TL) and total solar energy transmittance (TTS). Therefore, the laminated glass 100 has a good heat insulation effect.

The specific composition and effect experiment of the laminated glass 100 will be described below.

Examples 1 to 11 and comparative examples 1 to 7 all provide laminated glass 100. Compositions of outer glass 10 and inner glass 20 in the laminated glass 100 are illustrated in table 1, and thicknesses and total-iron contents of the outer glass 10 and the inner glass 20 are illustrated in table 2. An intermediate layer 30 is made of PVB and has a thickness of 0.76 mm.

The effect data of the laminated glass 100 of examples 1 to 11 and comparative examples 1 to 7 are measured, the results of which are illustrated in table 3. The effect data includes cost, melting difficulty, TL, and TTS. The TL and TTS are obtained by measuring samples of the laminated glass 100 according to “ISO 9050 Glass in building—Determination of light transmittance, solar direct transmittance, total solar energy transmittance, ultraviolet transmittance and related glazing factors”.

TABLE 1
compositions of outer glass 10 and inner glass 20 in laminated glass 100 of
examples 1 to 11 and comparative examples 1 to 7

| No. | | SiO₂ | Al₂O₃ | Na₂O | K₂O | CaO | MgO | Fe₂O₃ | Co₂O₃ | B₂O3 | P₂O₅ | Li₂O |
|---|---|---|---|---|---|---|---|---|---|---|---|---|
| example 1 | outer | 71.5 | 0.5 | 13.8 | 0.36 | 8.8 | 3.2 | 1.8 | 0.03 | 0 | 0.01 | 0 |
| | glass 10 | | | | | | | | | | | |
| | inner | 71.5 | 4 | 16.8 | 1.5 | 0.2 | 4.7 | 1.2 | 0.02 | 0.04 | 0.04 | 0 |
| | glass 20 | | | | | | | | | | | |
| example 2 | outer | 71.5 | 0.5 | 13.8 | 0.36 | 9 | 3.2 | 1.6 | 0.025 | 0 | 0.015 | 0 |
| | glass 10 | | | | | | | | | | | |
| | inner | 71.5 | 4 | 17 | 1.5 | 0.2 | 4.7 | 1 | 0.015 | 0.04 | 0.045 | 0 |
| | glass 20 | | | | | | | | | | | |
| example 3 | outer | 71.5 | 0.5 | 14 | 0.36 | 9 | 3.2 | 1.4 | 0.02 | 0 | 0.02 | 0 |
| | glass 10 | | | | | | | | | | | |
| | inner | 71.5 | 4 | 16.9 | 2 | 0.2 | 4.7 | 0.6 | 0.01 | 0.04 | 0.05 | 0 |
| | glass 20 | | | | | | | | | | | |
| example 4 | outer | 71.5 | 0.5 | 14 | 0.36 | 9 | 3.4 | 1.2 | 0.02 | 0 | 0.02 | 0 |
| | glass 10 | | | | | | | | | | | |
| | inner | 61 | 13 | 15 | 6.2 | 0 | 4.6 | 0.1 | 0.0015 | 0.05 | 0.0485 | 0 |
| | glass 20 | | | | | | | | | | | |
| example 5 | outer | 71.5 | 0.5 | 14.2 | 0.56 | 9 | 3.2 | 1 | 0.015 | 0 | 0.025 | 0 |
| | glass 10 | | | | | | | | | | | |
| | inner | 61 | 13 | 14.5 | 6.2 | 0 | 4.6 | 0.08 | 0.0012 | 0.05 | 0.0688 | 0.5 |
| | glass 20 | | | | | | | | | | | |
| example 6 | outer | 70.4 | 4 | 16.8 | 1.5 | 0.2 | 4.7 | 1.8 | 0.03 | 0.03 | 0.04 | 0.5 |
| | glass 10 | | | | | | | | | | | |
| | inner | 70.4 | 4 | 16.8 | 1.5 | 0.2 | 4.7 | 1.8 | 0.03 | 0.03 | 0.04 | 0.5 |
| | glass 20 | | | | | | | | | | | |
| example 7 | outer | 71.5 | 0.5 | 13.8 | 0.36 | 8.8 | 3.2 | 1.8 | 0.03 | 0 | 0.01 | 0 |
| | glass 10 | | | | | | | | | | | |
| | inner | 70.4 | 4 | 16.8 | 1.5 | 0.2 | 4.7 | 1.8 | 0.03 | 0.03 | 0.04 | 0.5 |
| | glass 20 | | | | | | | | | | | |
| example 8 | outer | 71.5 | 0.5 | 13.8 | 0.36 | 9 | 3.2 | 1.6 | 0.025 | 0 | 0.015 | 0 |
| | glass 10 | | | | | | | | | | | |
| | inner | 71.5 | 4 | 16.8 | 1.5 | 0.2 | 4.7 | 1.2 | 0.02 | 0.04 | 0.04 | 0 |
| | glass 20 | | | | | | | | | | | |
| example 9 | outer | 71.5 | 0.5 | 14 | 0.36 | 9 | 3.2 | 1.4 | 0.02 | 0 | 0.02 | 0 |
| | glass 10 | | | | | | | | | | | |
| | inner | 71.5 | 4 | 17 | 1.7 | 0.2 | 4.7 | 0.8 | 0.012 | 0.04 | 0.048 | 0 |
| | glass 20 | | | | | | | | | | | |
| example 10 | outer | 71.5 | 0.5 | 14 | 0.36 | 9 | 3.4 | 1.2 | 0.02 | 0 | 0.02 | 0 |
| | glass 10 | | | | | | | | | | | |
| | inner | 61 | 13 | 15 | 6.2 | 0 | 4.6 | 0.1 | 0.0015 | 0.05 | 0.0485 | 0 |
| | glass 20 | | | | | | | | | | | |
| example 11 | outer | 71.5 | 0.5 | 14.2 | 0.56 | 9 | 3.2 | 1 | 0.015 | 0 | 0.025 | 0 |
| | glass 10 | | | | | | | | | | | |
| | inner | 61 | 13 | 14.5 | 6.2 | 0 | 4.6 | 0.08 | 0.0012 | 0.05 | 0.0688 | 0.5 |
| | glass 20 | | | | | | | | | | | |
| comparative | outer | 71.5 | 0.5 | 14.2 | 0.56 | 9 | 3.2 | 1 | 0.015 | 0 | 0.025 | 0 |
| example | glass 10 | | | | | | | | | | | |
| 1 | inner | 71.5 | 4 | 17 | 1.5 | 0.2 | 4.7 | 1 | 0.015 | 0.04 | 0.045 | 0 |
| | glass 20 | | | | | | | | | | | |
| comparative | outer | 71.5 | 0.5 | 13.6 | 0.36 | 8.8 | 3.2 | 2 | 0.03 | 0 | 0.01 | 0 |
| example | glass 10 | | | | | | | | | | | |
| 2 | inner | 61 | 13 | 15 | 6.2 | 0 | 4.6 | 0.1 | 0.0015 | 0.05 | 0.0485 | 0 |
| | glass 20 | | | | | | | | | | | |
| comparative | outer | 71.5 | 0.5 | 14.4 | 0.56 | 9 | 3.2 | 0.8 | 0.012 | 0 | 0.028 | 0 |
| example | glass 10 | | | | | | | | | | | |
| 3 | inner | 61 | 13 | 14.6 | 6.2 | 0 | 4.6 | 0.01 | 0 | 0.05 | 0.04 | 0.5 |
| | glass 20 | | | | | | | | | | | |
| comparative | outer | 71.5 | 0.5 | 14.4 | 0.56 | 9 | 3.2 | 0.8 | 0.012 | 0 | 0.028 | 0 |
| example | glass 10 | | | | | | | | | | | |
| 4 | inner | 70.4 | 4 | 16.6 | 1.5 | 0.2 | 4.7 | 2 | 0.03 | 0.03 | 0.04 | 0.5 |
| | glass 20 | | | | | | | | | | | |
| comparative | outer | 71.5 | 0.5 | 14 | 0.36 | 9 | 3.4 | 1.2 | 0.02 | 0 | 0.02 | 0 |
| example | glass 10 | | | | | | | | | | | |
| 5 | inner | 61 | 13 | 14.6 | 6.2 | 0 | 4.6 | 0.01 | 0 | 0.05 | 0.04 | 0.5 |
| | glass 20 | | | | | | | | | | | |
| comparative | outer | 71.5 | 0.5 | 14.4 | 0.56 | 9 | 3.2 | 0.8 | 0.012 | 0 | 0.028 | 0 |
| example | glass 10 | | | | | | | | | | | |
| 6 | inner | 61 | 13 | 14.6 | 6.2 | 0 | 4.6 | 0.01 | 0 | 0.05 | 0.04 | 0.5 |
| | glass 20 | | | | | | | | | | | |
| comparative | outer | 71.5 | 0.5 | 13.6 | 0.36 | 8.8 | 3.2 | 2 | 0.03 | 0 | 0.01 | 0 |
| example | glass 10 | | | | | | | | | | | |
| 7 | inner | 70.4 | 4 | 16.6 | 1.5 | 0.2 | 4.7 | 2 | 0.03 | 0.03 | 0.04 | 0.5 |
| | glass 20 | | | | | | | | | | | |

TABLE 2
thicknesses and total-iron contents of outer glass 10 and inner glass 20 in laminated glass 100 of
examples 1 to 11 and comparative examples 1 to 7

| | | outer glass 10 | | inner glass 20 | Wₒᵤₜₑᵣ * Tₒᵤₜₑᵣ + |
|---|---|---|---|---|---|
| | outer glass 10 | Fe₂O₃ content/ | inner glass 20 | Fe₂O₃ content/ | Wᵢₙₙₑᵣ * Tᵢₙₙₑᵣ |
| No. | thickness/mm | wt % | thickness/mm | wt % | (%) |
| example 1 | 2.1 | 1.8 | 1.1 | 1.2 | 5.1 |
| example 2 | 2.5 | 1.6 | 1.1 | 1 | 5.1 |
| example 3 | 3.2 | 1.4 | 1.1 | 0.6 | 5.14 |
| example 4 | 3.5 | 1.2 | 1.1 | 0.1 | 4.31 |
| example 5 | 4 | 1 | 1.1 | 0.08 | 4.088 |
| example 6 | 4 | 1.8 | 1.1 | 1.8 | 9.18 |
| example 7 | 2.1 | 1.8 | 0.7 | 1.8 | 5.04 |
| example 8 | 2.5 | 1.6 | 0.7 | 1.2 | 4.84 |
| example 9 | 3.2 | 1.4 | 0.7 | 0.8 | 5.04 |
| example 10 | 3.5 | 1.2 | 0.7 | 0.1 | 4.27 |
| example 11 | 4 | 1 | 0.7 | 0.08 | 4.056 |
| comparative | 2.1 | 1 | 0.7 | 1 | 2.8 |
| example 1 | | | | | |
| comparative | 2.1 | 2 | 1.1 | 0.1 | 4.31 |
| example 2 | | | | | |
| comparative | 2.1 | 0.8 | 1.1 | 0.01 | 1.691 |
| example 3 | | | | | |
| comparative | 3.5 | 0.8 | 0.7 | 2 | 4.2 |
| example 4 | | | | | |
| comparative | 3.5 | 1.2 | 1.1 | 0.01 | 4.211 |
| example 5 | | | | | |
| comparative | 3.5 | 0.8 | 1.1 | 0.01 | 2.811 |
| example 6 | | | | | |
| comparative | 4 | 2 | 1.1 | 2 | 10.2 |
| example 7 | | | | | |

TABLE 3
effect data of laminated glass 100 of examples 1 to 11 and comparative examples 1 to 7

| | | outer glass | | inner glass | | |
|---|---|---|---|---|---|---|
| | outer glass | 10 | inner glass | 20 | laminated | laminated |
| | 10 | batch melting | 20 | batch melting | glass 100 | glass 100 |
| No. | batch cost | difficulty | batch cost | difficulty | TL/% | TTS/% |
| example 1 | low | medium | low | low | 17.1 | 31.6 |
| example 2 | low | medium | low | low | 17.0 | 31.5 |
| example 3 | low | medium | low | low | 16.9 | 31.3 |
| example 4 | low | low | low | low | 22.5 | 36.8 |
| example 5 | low | low | low | low | 24.2 | 38.4 |
| example 6 | low | medium | low | medium | 7.0 | 21.1 |
| example 7 | low | medium | low | medium | 17.5 | 31.9 |
| example 8 | low | medium | low | low | 18.8 | 33.2 |
| example 9 | low | medium | low | low | 17.5 | 31.9 |
| example 10 | low | low | low | low | 22.8 | 37.1 |
| example 11 | low | low | low | low | 24.5 | 38.7 |
| comparative | low | low | low | low | 35.8 | 49.6 |
| example 1 | | | | | | |
| comparative | low | high | low | low | 22.5 | 36.8 |
| example 2 | | | | | | |
| comparative | low | low | high | low | 70.8 | 68.9 |
| example 3 | | | | | | |
| comparative | low | low | low | high | 23.3 | 37.6 |
| example 4 | | | | | | |
| comparative | low | low | high | low | 23.2 | 37.5 |
| example 5 | | | | | | |
| comparative | low | low | high | low | 35.7 | 49.5 |
| example 6 | | | | | | |
| comparative | low | high | low | high | 5.5 | 18.7 |
| example 7 | | | | | | |

As can be seen from table 1 to table 3, in comparative example 1, both a content Wₒᵤₜₑᵣ of total iron in the outer glass 10 and a content Wᵢₙₙₑᵣ of total iron in the inner glass 20 are 1 wt %, the contents of the total iron are in an appropriate range, but Wₒᵤₜₑᵣ*Tₒᵤₜₑᵣ+Wᵢₙₙₑᵣ*Tᵢₙₙₑᵣ is too low and does not satisfy the range of 4% to 10%. The resulting laminated glass 100 in comparative example 1 has an excessively high visible TL and TTS and has an insufficient heat insulation performance, which cannot satisfy actual heat insulation requirements when used as sunroof glass or the like. In comparative example 7, the content Wₒᵤₜₑᵣ of the total iron in the outer glass 10 is as high as 2 wt %, the content Wᵢₙₙₑᵣ of the total iron in the inner glass 20 is as high as 2 wt %, the contents of a colorant Fe₂O₃ in the outer glass 10 and the inner glass 20 are both too high, and Wₒᵤₜₑᵣ*Tₒᵤₜₑᵣ+Wᵢₙₙₑᵣ*Tᵢₙₙₑᵣ in the laminated glass 100 is too high, exceeding 10 wt %. Although the resulting laminated glass 100 in comparative example 7 has a relatively low visible TL and TTS, there are difficulties in the melting, fining, and homogenizing of glass melts during production of the outer glass 10 and the inner glass 20, and there are difficulties in the mass production of a raw sheet of the outer glass 10 and a raw sheet of the inner glass 20. In the laminated glass 100 provided in examples 1 to 11 of the present disclosure, both the content Wₒᵤₜₑᵣ of the total iron in the outer glass 10 and the content Wᵢₙₙₑᵣ of the total iron in the inner glass 20 are appropriate, and neither the outer glass 10 nor the inner glass 20 uses conventional clear glass, so the cost is not too high. In addition, the batch melting difficulties of the compositions of the outer glass 10 and the inner glass 20 are not high, so that the raw sheets of the outer glass 10 and the inner glass 20 are easily formed, and thus the laminated glass 100 is easily prepared. Furthermore, the laminated glass 100 provided in examples 1 to 11 of the present disclosure has a low visible TL and TTS and has a high heat insulation performance, which can fully satisfy the requirements of the sunroof glass and the like for heat insulation performance.

In comparative example 2, the content Wₒᵤₜₑᵣ of the total iron in the outer glass 10 is as high as 2 wt %, which is too high, and the batch melting difficulty of the composition of the outer glass 10 makes it difficult to produce the raw sheet of the outer glass 10. In comparative example 4, the content Wᵢₙₙₑᵣ of the total iron in the inner glass 20 is as high as 2 wt %, there are difficulties in the melting, fining, and homogenizing of glass melts during production of the inner glass 20, and there are difficulties in the mass production of the raw sheet of the inner glass 20. In the laminated glass 100 provided in examples 1 to 11 of the present disclosure, the content Wₒᵤₜₑᵣ of the total iron in the outer glass 10 is controlled between 1 wt % and 1.9 wt %, which ensures that the composition batches of the outer glass 10 can be easily melted, fined, and homogenized, thereby guaranteeing the production of the raw sheet of the outer glass 10. In some embodiments, Wₒᵤₜₑᵣ preferably ranges from 1.1 wt % to 1.8 wt %. The content Wᵢₙₙₑᵣ of the total iron in the inner glass 20 is controlled between 0.08 wt % and 1.9 wt %, which ensures that the composition batches of the inner glass 20 can be easily melted, fined, and homogenized, thereby guaranteeing the production of the raw sheet of the inner glass 20. In some embodiments, Wᵢₙₙₑᵣ preferably ranges from 0.5 wt % to 1.8 wt %, and further Wᵢₙₙₑᵣ preferably ranges from 1.0 wt % to 1.8 wt %.

In comparative example 3, the laminated glass 100 belongs to a conventional combination in which the outer glass 10 is green glass and the inner glass 20 is ultra-clear glass, and expensive and high purity grade raw materials such as silica sand are required for the production of the inner glass 20. In addition, during melting, fining, and homogenizing of the ultra-clear glass or clear glass in a glass furnace, since the glass melts have a high transmittance and do not absorb heat, more fuel supply is required to reach a specific temperature, and accordingly, refractory bricks of the glass furnace are required to have a high refractory grade and are easily damaged, the raw material cost and the production energy consumption cost of the clear glass are significant. Furthermore, the laminated glass 100 of comparative example 3 has an excessively high visible TL and TTS, and has a poor heat insulation performance, which cannot satisfy actual heat insulation requirements when used as the sunroof glass or the like. In comparative example 5, the laminated glass 100 belongs to a conventional combination in which the outer glass 10 is grey glass and the inner glass 20 is ultra-clear glass, and the production cost of the raw sheet of the inner glass 20 is too high. In the laminated glass 100 provided in examples 1 to 11 of the present disclosure, the outer glass 10 and the inner glass 20 both contain the colorant Fe₂O₃, neither of which uses untinted ultra-clear glass or clear glass. The laminated glass 100 of comparative example 6 belongs to a conventional combination in which the outer glass 10 is green glass and the inner glass 20 is ultra-clear glass. The laminated glass 100 of comparative example 6 has an excessively high visible TL and TTS and has a poor heat insulation performance, and the production cost of the raw sheet of the inner glass 20 is too high. Compared with using the ultra-clear glass or clear glass, the laminated glass 100 of the present disclosure is tinted glass containing iron, which ensures the optical performance of the laminated glass and reduces the cost of the outer glass 10 and the inner glass 20, thereby reducing the production cost of the laminated glass 100.

The above embodiments are only preferred embodiments of the disclosure and cannot be understood as limitations on the disclosure. Those of ordinary skill in the art can understand that all or part of methods for realizing the above embodiments, and equivalent changes made in accordance with the claims of the disclosure, still fall within the scope covered by the disclosure.

What is claimed is:

1. Laminated glass, comprising outer glass, an intermediate layer, and inner glass, wherein the intermediate layer is located between the outer glass and the inner glass, a composition of the outer glass and a composition of the inner glass both comprise total iron expressed as Fe₂O₃, a mass percentage content of the total iron in the outer glass is Wₒᵤₜₑᵣ based on a mass of the outer glass, a mass percentage content of the total iron in the inner glass is Wᵢₙₙₑᵣ based on a mass of the inner glass, and Wₒᵤₜₑᵣ and Wᵢₙₙₑᵣ satisfy: 10%≥Wₒᵤₜₑᵣ*Tₒᵤₜₑᵣ+Wᵢₙₙₑᵣ*Tᵢₙₙₑᵣ≥4%, Tₒᵤₜₑᵣ being a thickness of the outer glass in a unit of mm, and Tᵢₙₙₑᵣ being a thickness of the inner glass in a unit of mm.

2. The laminated glass of claim 1, wherein Wₒᵤₜₑᵣ ranges from 1 wt % to 1.9 wt %, and Wᵢₙₙₑᵣ ranges from 0.08 wt % to 1.9 wt %.

3. The laminated glass of claim 2, wherein Tₒᵤₜₑᵣ ranges from 1.6 mm to 5.0 mm, and Tᵢₙₙₑᵣ ranges from 0.1 mm to 1.2 mm.

4. The laminated glass of claim 1, wherein the laminated glass has a total solar energy transmittance less than or equal to 45%.

5. The laminated glass of claim 1, wherein the laminated glass has a visible light transmittance less than or equal to 25%.

6. The laminated glass of claim 1, wherein in the outer glass, a ratio of a content of ferrous iron to a content of ferric iron ranges from 0.25 to 0.67; and in the inner glass, a ratio of a content of ferrous iron to a content of ferric iron ranges from 0.25 to 0.67.

7. The laminated glass of claim 1, wherein the composition of the outer glass further comprises total cobalt expressed as Co₂O₃, a mass percentage content of the total cobalt in the outer glass is W_{Co} based on the mass of the outer glass, and W_{Co} ranges from 0.01 wt % to 0.04 wt %.

8. The laminated glass of claim 7, wherein Wₒᵤₜₑᵣ:W_{Co}=55-75.

9. The laminated glass of claim 1, wherein based on the mass of the outer glass, the composition of the outer glass comprises SiO₂ of 65 wt %-75 wt %, Na₂O of 10 wt %-20 wt %, CaO of 5 wt %-15 wt %, MgO of 0 wt %-5 wt %, K₂O of 0 wt %-3 wt %, Al₂O₃ of 0 wt %-5 wt %, Fe₂O₃ of 1 wt %-1.9 wt %, Co₂O₃ of 0.01 wt %-0.1 wt %, Cr₂O₃ of 0 wt %-0.1 wt %, CeO₂ of 0 wt %-0.1 wt %, MnO of 0 wt %-0.01 wt %, NiO of 0 wt %-0.01 wt %, ZrO₂ of 0 wt %-1 wt %, B₂O₃ of 0 wt %-1 wt %, and P₂O₅ of 0 wt %-1 wt %.

10. The laminated glass of claim 1, wherein based on the mass of the inner glass, the composition of the inner glass comprises SiO₂ of 55 wt %-65 wt %, Al₂O₃ of 0 wt %-22 wt %, Na₂O of 8 wt %-18 wt %, Li₂O of 0 wt %-5 wt %, CaO of 0 wt %-2 wt %, MgO of 0 wt %-5 wt %, K₂O of 0 wt %-10 wt %, Fe₂O₃ of 0.08 wt %-1.9 wt %, ZrO₂ of 0 wt %-2 wt %, B₂O₃ of 0 wt %-5 wt %, and P₂O₅ of 0 wt %-1 wt %.

11. The laminated glass of claim 1, wherein the composition of the inner glass comprises alkaline-earth metal oxide, and a total content of the alkaline-earth metal oxide is less than 5 wt % based on the mass of the inner glass.

12. The laminated glass of claim 1, wherein a transmitted color of the outer glass has a value of L ranging from 29 to 56, a value of a ranging from −5 to −2, and a value of b ranging from 2 to 4 in a color space Lab.

13. The laminated glass of claim 1, wherein a transmitted color of the inner glass has a value of L ranging from 40 to 92, a value of a ranging from −4 to 1, and a value of b ranging from 0 to 2 in a color space Lab.

14. A vehicle, comprising a vehicle body and laminated glass, wherein the laminated glass comprises outer glass, an intermediate layer, and inner glass, wherein the intermediate layer is located between the outer glass and the inner glass, a composition of the outer glass and a composition of the inner glass both comprise total iron expressed as Fe₂O₃, a mass percentage content of the total iron in the outer glass is Wₒᵤₜₑᵣ based on a mass of the outer glass, a mass percentage content of the total iron in the inner glass is Wᵢₙₙₑᵣ based on a mass of the inner glass, and Wₒᵤₜₑᵣ and Wᵢₙₙₑᵣ satisfy: 10%≥Wₒᵤₜₑᵣ*Tₒᵤₜₑᵣ+Wᵢₙₙₑᵣ*Tᵢₙₙₑᵣ≥4%, Tₒᵤₜₑᵣ being a thickness of the outer glass in a unit of mm, and Tᵢₙₙₑᵣ being a thickness of the inner glass in a unit of mm;
wherein the laminated glass is mounted at the vehicle body.

15. The vehicle of claim 14, wherein Wₒᵤₜₑᵣ ranges from 1 wt % to 1.9 wt %, and Wᵢₙₙₑᵣ ranges from 0.08 wt % to 1.9 wt %.

16. The vehicle of claim 14, wherein the laminated glass has a total solar energy transmittance less than or equal to 45%.

17. The vehicle of claim 14, wherein the laminated glass has a visible light transmittance less than or equal to 25%.

18. The vehicle of claim 14, wherein in the outer glass, a ratio of a content of ferrous iron to a content of ferric iron ranges from 0.25 to 0.67; and in the inner glass, a ratio of a content of ferrous iron to a content of ferric iron ranges from 0.25 to 0.67.

19. The vehicle of claim 14, wherein the composition of the outer glass further comprises total cobalt expressed as Co₂O₃, a mass percentage content of the total cobalt in the outer glass is W_{Co}. based on the mass of the outer glass, and W_{Co} ranges from 0.01 wt % to 0.04 wt %.

20. The vehicle of claim 14, wherein a transmitted color of the outer glass has a value of L ranging from 29 to 56, a value of a ranging from −5 to −2, and a value of b ranging from 2 to 4 in a color space Lab.
